(19) United States
(12) Patent Application Publication
(10) Pub. No.: US 2011/0279514 A1
(43) Pub. Date: Nov. 17, 2011

(54) AQUEOUS INKJET INK

(75) Inventors: Ryozo Akiyama, Shizuoka-ken (JP); Atsushi Kubota, Shizuoka-ken (JP); Maiko Yoshida, Shizuoka-ken (JP); Takafumi Hara, Shizuoka-ken (JP); Chie Tonohiro, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/097,672

(22) Filed: Apr. 29, 2011

Related U.S. Application Data
(60) Provisional application No. 61/333,365, filed on May 11, 2010.

(51) Int. Cl. B41J 2/015; C09D 11/02

(52) U.S. Cl. 347/20; 106/31.6; 106/31.75; 106/31.78

(57) ABSTRACT

According to one embodiment, an aqueous inkjet ink includes water in an amount of from 15 to 50% by mass of the total amount of the ink, a glycol mixture in an amount of from 34 to 80% by mass of the total amount of the ink, and a pigment in an amount of from 2 to 20% by mass of the total amount of the ink. The glycol mixture contains 40 to 70% by mass of propylene glycol, with the remainder being isoprene glycol.

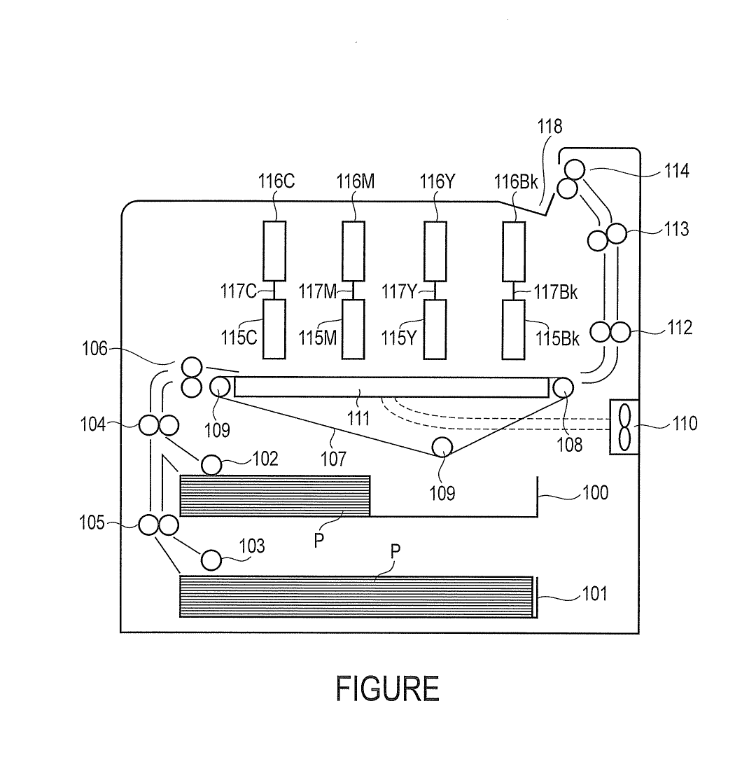

### CROSS-REFERENCE TO RELATED APPLICATION

This application is based upon and claims the benefit of priority from U.S. Provisional Application No. 61/333,365 filed on May 11, 2010, the entire contents of which are incorporated herein by reference.

### FIELD

Embodiments described herein relate generally to an aqueous inkjet ink.

### BACKGROUND

Recently, an inkjet ink in which a pigment is dispersed in an aqueous medium is proposed. An ink using a pigment is excellent in water resistance and light resistance as compared with an ink using a water-soluble dye.

The inkjet ink should have a property suitable for ejection from an inkjet head. The inkjet ink for use in printing on a paper medium is required to suppress deformation of the paper medium as much as possible and to enable the formation of a high quality image on the paper medium.

### BRIEF DESCRIPTION OF THE DRAWINGS

The single FIGURE shows an example of an inkjet recording apparatus to which an embodiment is applied.

### DETAILED DESCRIPTION

According to one embodiment, an aqueous inkjet ink includes water in an amount of from 15 to 50% by mass of the total amount of the ink, a glycol mixture in an amount of from 34 to 80% by mass of the total amount of the ink, and a pigment in an amount of from 2 to 20% by mass of the total amount of the ink. The glycol mixture contains 40 to 70% by mass of propylene glycol, with the remainder being isoprene glycol.

Hereinafter, embodiments will be specifically described.

In an inkjet printing apparatus shown in the FIGURE, paper cassettes 100 and 101 contain paper P of different sizes, respectively. A paper feed roller 102 or 103 takes out the paper P in response to the selected paper size from the paper cassette 100 or 101 and conveys the paper P to conveying roller pairs 104 and 105 and a resist roller pair 106.

A tension is given to a conveying belt 107 by a driving roller 108 and two driven rollers 109. Through-holes are provided at predetermined intervals in the conveying belt 107, and for the purpose of adsorbing the paper P onto the conveying belt 107, a negative pressure chamber 111 connected to a fan 110 is installed in the inside of the conveying belt 107. Conveying roller pairs 112, 113, and 114 are installed in the downstream of the paper conveying direction of the conveying belt 107.

Four rows of inkjet heads which eject inks on paper according to image data are disposed above the conveying belt 107. An inkjet head 115C which ejects a cyan (C) ink, an inkjet head 115M which ejects a magenta (M) ink, an inkjet head 115Y which ejects a yellow (Y) ink, and an inkjet head 115Bk which ejects a black (Bk) ink are arranged in this order from the upstream. Further, these inkjet heads 115C, 115M, 115Y, and 115Bk are provided with a cyan (C) ink cartridge 116C, a magenta (M) ink cartridge 116M, a yellow (Y) ink cartridge 116Y, and a black (Bk) ink cartridge 116Bk, respectively, each of which contains an ink of each color. These cartridges are connected to the inkjet heads via tubes 117C, 117M, 117Y, and 117Bk, respectively.

An image forming operation of the inkjet printing apparatus having such a structure will be described below.

First, image processing for printing by an image processing unit (not shown) is initiated, and image data for printing are transferred to the respective inkjet heads 115C, 115M, 115Y, and 115Bk. Also, the paper P of a selected paper size is taken out one by one from the paper cassette 100 or 101 by the paper feed roller 102 or 103 and conveyed to the conveying roller pairs 104 and 105 and the resist roller pair 106. The resist roller pair 106 corrects a skew of the paper P and conveys the paper P at a given timing.

The negative pressure chamber 111 draws air through the holes of the conveying belt 107, and therefore, the paper P is conveyed in a state of being adsorbed onto the conveying belt 107 in a lower side of the inkjet heads 115C, 115M, 115Y, and 115Bk. In this manner, the respective inkjet heads 115C, 115M, 115Y, and 115Bk and the paper P can keep a fixed space from each other. The ink of each color is ejected from each of the inkjet heads 115C, 115M, 115Y, and 115Bk in synchronization with the timing for conveying the paper P from the resist roller pair 106. Thus, a color image is formed at a desired position on the paper P. The paper P having an image formed thereon is discharged to a paper discharge tray 118 by the conveying roller pairs 112, 113, and 114.

Each ink cartridge stores an aqueous inkjet ink according to one embodiment.

The aqueous inkjet ink according to this embodiment contains water in an amount of from 15 to 50% by mass of the total amount of the ink, a glycol mixture in an amount of from 34 to 80% by mass of the total amount of the ink, and a pigment in an amount of from 2 to 20% by mass of the total amount of the ink. The glycol mixture contains 40 to 70% by mass of propylene glycol, with the remainder being isoprene glycol.

That is, a dispersion medium of the aqueous inkjet ink according to this embodiment is composed of water and the glycol mixture. The dispersion medium contains water, propylene glycol, and isoprene glycol in predetermined amounts, respectively. By using such a dispersion medium, the aqueous inkjet ink according to this embodiment can suppress deformation of a paper medium as much as possible and can form a high quality image on the paper medium.

The paper medium as used herein generally refers to a medium made of paper to be used for printing. The paper medium is broadly divided into coated paper coated with a material for increasing print properties such as art paper or coat paper and non-coated paper to be used for utilizing the properties of paper itself. The paper medium is applied to a variety of uses such as books, documents, newspapers, packages, printer sheets, etc. The paper medium also includes corrugated cardboard, containers made of paper, and thick paper such as cardboard. For example, so-called plain paper such as copy paper to be used in a copier or a printer for office or home use is a typical paper medium.

As described above, according to one embodiment, a pigment is dispersed in the dispersion medium containing water, propylene glycol, and isoprene glycol in predetermined amounts, respectively.

The pigment is not particularly limited, and either of an inorganic pigment and an organic pigment may be used. Examples of the inorganic pigment include titanium oxide and iron oxide. Further, a carbon black produced by a known method such as a contact method, a furnace method, or a thermal method can be used.

As the organic pigment, for example, an azo pigment (such as an azo lake pigment, an insoluble azo pigment, a condensed azo pigment, or a chelate azo pigment), a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, or a quinophthalone pigment), a dye chelate (such as a basic dye type chelate, or an acid dye type chelate), a nitro pigment, a nitroso pigment, aniline black, or the like can be used.

Specific examples of the carbon black which is used as a black ink include No. 2300, No. 900, MCF88, No. 33, No. 40, No. 45, No. 52, MA7, MA8, MA100, and No. 2200B (all of which are manufactured by Mitsubishi Chemical Corporation), Raven 5750, Raven 5250, Raven 5000, Raven 3500, Raven 1255, and Raven 700 (all of which are manufactured by Columbian Chemicals Company), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all of which are manufactured by Cabot Corporation), and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all of which are manufactured by Degussa AG).

Specific examples of the pigment which is used in a yellow ink include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14C, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 109, C.I. Pigment Yellow 110, C.I. Pigment Yellow 114, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185.

Specific examples of the pigment which is used in a magenta ink include C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 57:1, C.I. Pigment Red 112, C.I. Pigment Red 122, C.I. Pigment Red 123, C.I. Pigment Red 168, C.I. Pigment Red 184, C.I. Pigment Red 202, and C.I. Pigment Violet 19.

Specific examples of the pigment which is used in a cyan ink include C.I. Pigment Blue 1, C.I. Pigment Blue 2, C.I. Pigment Blue 3, C.I. Pigment Blue 15:3, C.I. Pigment Blue 15:4, C.I. Pigment Blue 15:34, C.I. Pigment Blue 16, C.I. Pigment Blue 22, C.I. Pigment Blue 60, C.I. Vat Blue 4, and C.I. Vat Blue 60.

Since the ink is an inkjet ink, it is preferred that the average particle diameter of such a pigment is within a range of about 10 to 300 nm. It is more preferred that the average particle diameter of the pigment is within a range of about 10 to 200 nm.

The average particle diameter of the pigment can be determined using a particle size distribution analyzer employing a dynamic light scattering method. Examples of the particle size distribution analyzer include HPPS (Malvern Instruments Ltd.).

The pigment can be used in a state of a pigment dispersion. The pigment dispersion can be prepared by, for example, dispersing the pigment in water or an alcohol with a dispersant. Examples of the dispersant include a surfactant, a water-soluble resin, and a water-insoluble resin. Alternatively, a self-dispersion type pigment may be used. The self-dispersion type pigment is a pigment which can be dispersed in water or the like without using a dispersant, and to which at least one functional group selected from a carbonyl group, a carboxyl group, a hydroxyl group, and a sulfone group or a salt thereof is bound through a surface treatment. Examples of the surface treatment include a vacuum plasma treatment, a diazo coupling treatment, and an oxidation treatment. The self-dispersion type pigment is obtained by grafting a functional group or a molecule containing a functional group on the surface of a pigment through such a surface treatment.

The content of the pigment in the ink is preferably within a range of 2 to 20% by mass of the total amount of the ink. If the content of the pigment is within this range, a printed matter having a necessary image density can be formed without causing any disadvantage with respect to the storage stability or ejection performance of the ink. The ink containing the pigment in an amount of from 3 to 6% by mass of the total amount of the ink has a viscosity suitable for ejection from the inkjet head over a wide temperature range of about 20 to 50° C. Moreover, the quality of an image formed using this ink is favorable.

The pigment dispersion is mixed with the dispersion medium containing water, propylene glycol and isoprene glycol, whereby the aqueous inkjet ink according to this embodiment is obtained.

The content of water is from 15 to 50% by mass of the total amount of the ink. If the content of water is less than 15% by mass, a viscosity within a range suitable as an inkjet ink cannot be obtained. Therefore, the ejection performance from the inkjet head is lowered. On the other hand, if the content of water exceeds 50% by mass of the total amount of the ink, it is difficult to suppress deformation of paper. The content of water is preferably from 30 to 40% by mass of the total amount of the ink.

A glycol mixture containing propylene glycol and isoprene glycol accounts for 34 to 80% by mass of the total amount of the ink. A water-soluble organic solvent such as propylene glycol or isoprene glycol has a moderate moisture-retaining property, and by using propylene glycol and isoprene glycol in combination, the performance of suppressing deformation of paper can be increased.

If the content of the glycol mixture is less than 34% by mass of the total amount of the ink, it is difficult to suppress deformation of paper. On the other hand, if the content of the glycol mixture exceeds 80% by mass of the total amount of the ink, the ejection performance from the inkjet head is lowered. The content of the glycol mixture is preferably from 54 to 64% by mass of the total amount of the ink.

Further, the content of propylene glycol in the glycol mixture is from 40 to 70% by mass of the total amount of the glycol mixture, and the remainder is isoprene glycol. By combining the glycol mixture containing two types of glycols at such a ratio with water in a predetermined amount, the performance of suppressing deformation of paper was dramatically improved. This finding was discovered by the present inventors. The content of propylene glycol is preferably from 50 to 70% by mass of the total amount of the glycol mixture. In this case, the storage stability of the ink is increased. This is because propylene glycol has a lower effect on the dispersion stability of the pigment than isoprene glycol and is less likely to cause aggregation of the pigment.

The aqueous inkjet ink according to this embodiment may contain the following components within a range that does not deteriorate the properties: for example, polyhydric alcohols such as ethylene glycol, diethylene glycol, polyethylene glycol, polypropylene glycol, 1,5-pentanediol, 1,6-hexanediol, 1,2-hexanediol, glycerin, 1,2,6-hexanetriol, 1,2,4-butanetriol, 1,2,3-butanetriol, and 3-methyl-1,3,5-pentanetriol; nitrogen-containing heterocyclic compounds such as N-methyl-2-pyrrolidone, N-hydroxyethyl-2-pyrrolidone, 2-pyrrolidone, 1,3-dimethyl imidazolidinone, and ε-caprolactam; amines such as monoethanolamine, diethanolamine, triethanolamine, monoethylamine, diethylamine, and triethylamine; sulfur-containing compounds such as dimethylsulfoxide, sulfolane, and thiodiethanol; propylene carbonate, ethylene carbonate, γ-butyrolactone, and the like.

The aqueous inkjet ink according to this embodiment preferably contains a compound that suppresses curling of paper (curling suppressing agent). If a curling suppressing agent is contained in the ink, not only the curling of paper is suppressed, but also the quality of an image obtained using the ink can be further more increased. For example, betaine, lauryl betaine, lauryl hydroxysulfobetaine, carboxybetaine, sulfobetaine, an aminocarboxylate, imidazolium betaine, lecithin, an alkylamine oxide, and the like have an action as a curling suppressing agent.

The curling suppressing agent can exhibit an effect as long as the agent is contained in the inkjet ink in an amount of from about 5 to 15% by mass of the total amount of the ink. Betaine compounds have a particularly high effect on the suppression of deformation of paper, and among these compounds, betaine has high solubility in water and high storage stability. These effects of betaine are exhibited when betaine is blended in the ink in an amount of from about 10 to 15% by mass of the total amount of the ink.

When the aqueous inkjet ink according to this embodiment is obtained, for example, a dispersion medium containing water, propylene glycol, and isoprene glycol in predetermined amounts, respectively, and a pigment dispersion are mixed. To the dispersion medium, an additive can be added as needed.

Since the ink according to this embodiment is for inkjet printing, it is necessary that the ink have a viscosity suitable for ejection from a nozzle of a head in an inkjet printer. Specifically, the viscosity of the ink at 25° C. is preferably from 5 to 50 mPa·s. If the viscosity of the ink is 30 mPa·s or less, the temperature of the inkjet head when the ink is ejected can be set to a relatively low temperature (for example, about 40° C. or lower).

In order to adjust the ejection performance, moisture-retaining property, storage stability, physical properties, and the like of the inkjet ink to be within an optimal range, a surfactant, a moisture-retaining agent, a resin, or the like may be additionally added to the ink within a range that does not deteriorate the effect.

Examples of the surfactant include polyoxyethylene alkyl ethers, polyoxyalkylene alkyl ethers, polyoxyethylene polycyclic phenyl ethers, polyoxyalkylene polycyclic phenyl ethers, and glycerin fatty acid esters.

Further, an acetylene glycol-based surfactant, a fluorine-based surfactant, or a nonionic surfactant can also be used. Examples of the acetylene glycol-based surfactant include 2,4,7,9-tetramethyl-5-decyne-4,7-diol, 3,6-dimethyl-4-octyne-3,6-diol, and 3,5-dimethyl-1-hexyn-3-ol. Specific examples thereof include Surfynol 104, Surfynol 82, Surfynol 465, Surfynol 485, and Surfynol TG (all of which are manufactured by Air Products, Inc.).

Examples of the fluorine-based surfactant include perfluoroalkyl ethylene oxide adducts, perfluoroalkyl amine oxides, perfluoroalkyl carboxylates, and perfluoroalkyl sulfonates. Specific examples thereof include Megafac F-443, Megafac F-444, Megafac F-470, and Megafac F-494 (all of which are manufactured by Dainippon Ink Chemical Industry, Co., Ltd.), Novec FC-430 and Novec FC-4430 (all of which are manufactured by 3M Co., Ltd.), and Surflon S-141, Surflon S-145, Surflon S-111N, and Surflon S-113 (all of which are manufactured by Seimi Chemical Co., Ltd.).

Examples of the nonionic surfactant include polyoxyethylene alkyl ethers, polyoxyethylene alkyl esters, polyoxyethylene sorbitan fatty esters, polyoxyethylene alkylphenyl ethers, polyoxyethylene alkylamines, and polyoxyethylene alkylamides.

It is desired that such a surfactant is added to such an extent that the addition thereof does not deteriorate the dispersion stability and the like of the ink. The surfactant can exhibit an effect without causing any disadvantage as long as the surfactant is contained in an amount of from about 0.5 to 2.0% by mass of the total amount of the ink.

Among the above-mentioned surfactants, for example, an acetylene glycol-based surfactant, a nonionic surfactant, or the like can be used as a dispersant for preparing a pigment dispersion.

Further, a salt may be used in combination. Examples of the salt include polyoxyethylene alkyl ether acetates, dodecylbenzene sulfonates, laurates, and salts of polyoxyethylene alkyl ether sulfates. The salt can exhibit an effect without causing any disadvantage as long as the salt is contained in an amount of from about 0.5 to 1.0% by mass of the total amount of the ink.

Further, in the aqueous inkjet ink according to this embodiment, a water-soluble resin may be contained. The water-soluble resin adjusts the viscosity of the ink, and also can improve the print quality such as abrasion property of a printed matter. Examples of the water-soluble resin include polyvinyl alcohol, hydroxypropyl cellulose, carboxymethyl cellulose, hydroxyethyl cellulose, methyl cellulose, a water-soluble acrylic resin, polyvinylpyrrolidone, gum Arabic, dextrin, casein, and peptin. In particular, a water-soluble acrylic resin is preferred because the fixability to a paper medium is improved without deteriorating the dispersibility of the pigment in the ink.

Among these water-soluble resins, for example, a water-soluble acrylic resin or the like can be used as a dispersant for preparing a pigment dispersion.

According to need, an additive such as a pH adjusting agent or an antiseptic or antifungal agent can be blended in the ink. Examples of the pH adjusting agent include potassium dihydrogen phosphate, disodium hydrogen phosphate, and sodium hydroxide.

As the antiseptic or antifungal agent, for example, sodium benzoate, sodium pentachlorophenol, sodium 2-pyridinethiol-1-oxide, sodium sorbate, sodium dehydroacetate, 1,2-dibenzisothiazolin-3-one (Proxel CRL, Proxel BDN, Proxel GXL, Proxel XL-2, or Proxel TN, all of which are manufactured by Imperial Chemical Industries Limited), or the like can be used.

By blending such an additive, the print image quality or storage stability can be further increased.

Hereinafter, specific examples of the aqueous inkjet ink will be shown.

Glycols shown in the following Table 1 and curling suppressing agents shown in the following Table 2 were prepared.

TABLE 1

| Abbreviation | Compound |
|---|---|
| PPG | Propylene glycol |
| IPG | Isoprene glycol |

TABLE 2

| Abbreviation | Compound |
|---|---|
| BT1 | Betaine |
| BT2 | Lauryl betaine |
| BT3 | Lauryl hydroxysulfobetaine |

The respective components were mixed with one another according to the formulation shown in the following Table 3, whereby each ink sample was prepared. In the table, the amount of each component is expressed in % by mass of the total amount of the inkjet ink. As the surfactant, Surfynol 465 was used.

As the pigment, two types of pigment dispersions, a self-dispersion type (DD1) and an active agent dispersion type (DD2) were prepared.

DD1: Carbon black dispersion liquid CAB-JET-300 (manufactured by Cabot Corporation)

DD2: Anionic active carbon black dispersion liquid SP-8796 (manufactured by Fuji Pigment Co., Ltd.)

In DD1, a predetermined pigment is dispersed in water. The average particle diameter of the pigment is about 120 nm. The amount of water contained in DD1 is included in the amount of water in the following Table 3. On the other hand, in DD2, a predetermined pigment is dispersed in an aqueous dispersion liquid along with a predetermined amount of a dispersant and the like. The average particle diameter of the pigment contained in DD2 is about 110 nm. The amount of water contained in DD2 is included in the amount of water in the following Table 3.

DD1 was used in No. 6 to No. 21 samples, and DD2 was used in the other samples.

As shown in the following Table 3, in all of the samples, the pigment dispersion was blended in an amount such that the solid content of the pigment was 5% by mass of the total amount of the ink.

Further, to all of the samples, an antiseptic was added in an amount of 0.2% by mass of the total amount of the ink. As the antiseptic, Proxel XL-2 (S) was used.

In the preparation of each ink sample, the respective components were mixed according to the formulation shown in the table, and the resulting mixture was stirred for 1 hour using a stirrer.

Thereafter, the mixture was filtered through a 1-μm membrane filter, whereby the sample was obtained.

TABLE 3

| | | | | Curling | | | | |
|---|---|---|---|---|---|---|---|---|
| | | | | suppressing | | | | |
| | | glycol | | agent | | | | |
| No. | Water | PPG | IPG | BT1 | BT2 | BT3 | Surfactant | Pigment |
| 1 | 8 | 54 | 30.5 | | | | 2.5 | 5 |
| 2 | 10 | 54 | 28.5 | | | | 2.5 | 5 |
| 3 | 15 | 54 | 23.5 | | | | 2.5 | 5 |
| 4 | 20 | 39 | 33.5 | | | | 2.5 | 5 |
| 5 | 20 | 44 | 28.5 | | | | 2.5 | 5 |
| 6 | 30 | 45 | 19 | | | | 1 | 5 |
| 7 | 30 | 32 | 32 | | | | 1 | 5 |
| 8 | 30 | 27 | 37 | | | | 1 | 5 |
| 9 | 40 | 30 | 24 | | | | 1 | 5 |
| 10 | 40 | 27 | 27 | | | | 1 | 5 |
| 11 | 40 | 25 | 29 | | | | 1 | 5 |
| 12 | 50 | 22 | 22 | | | | 1 | 5 |
| 13 | 50 | 19 | 25 | | | | 1 | 5 |
| 14 | 55 | 20 | 19 | | | | 1 | 5 |
| 15 | 60 | 17 | 17 | | | | 1 | 5 |
| 16 | 40 | 20 | 20 | 14 | | | 1 | 5 |
| 17 | 40 | 24 | 24 | | 6 | | 1 | 5 |
| 18 | 40 | 24 | 24 | | | 6 | 1 | 5 |
| 19 | 45 | 17 | 17 | 15 | | | 1 | 5 |
| 20 | 45 | 22 | 22 | | 5 | | 1 | 5 |
| 21 | 45 | 22 | 22 | | | 5 | 1 | 5 |

Printing was performed on plain paper using the thus obtained each ink sample, and the performance of suppressing deformation of paper and print quality were examined. As the plain paper, Toshiba Copy Paper was used, and as the printing apparatus, an inkjet printing apparatus provided with a piezoelectric head CB1 (manufactured by Toshiba Tec Corporation) was used.

Each ink sample was evaluated by the following evaluation methods.

### (Performance of Suppressing Deformation of Paper)

First, solid printing was performed in a 10 mm×100 mm area of plain paper at a 100% duty, whereby a print sample was obtained. By using a laser displacement meter, the degree of deformation of paper (the magnitude of paper warping: cockle size) was obtained and evaluated based on the following criteria according to the concave-convex amount (length).

A: less than 0.5 mm

B: 0.5 mm or more but less than 1.0 mm

C: 1.0 mm or more

### (Print Quality)

The print quality was evaluated as follows. First, characters and a solid image were printed on plain paper described above. Then, the printed characters were visually observed for the occurrence of bleeding or feathering. Further, by using an X-Rite densitometer, the density of the solid image on both sides of the paper was examined.

Further, according to the formula (circumferential length)² /(4π×area), the shape factor of each dot of the printed image was calculated. The shape factor is an evaluation value obtained by quantifying the degree of bleeding. The circumferential length and the area were determined by an image analysis using a dot analyzer. When the irregularity of the dot shape is small, the shape factor is close to 1. By comprehensively considering the image densities on both sides of the paper, and the shape factor, evaluation was performed according to the criteria shown in the following Table 4.

TABLE 4

| | Image density | Image density | |
|---|---|---|---|
| Evaluation | (front side) | (back side) | Shape factor |
| A | 1.25 or more | 0.2 or less | 1.0 or more but less than 1.8 |
| B | 1.2 or more | 0.3 or less | 1.8 or more but less than 2.6 |
| C | 1.1 or less | 0.4 or less | 2.6 or more |

In the following Table 5, the performance of suppressing deformation and print quality of each ink sample are summarized. An ink sample which was evaluated as C for at least one of the performance of suppressing deformation and print quality is outside the acceptable range.

TABLE 5

| | Performance of | |
|---|---|---|
| No. | suppressing deformation | Print quality |
| 1 | A | C |
| 2 | A | C |
| 3 | A | B |
| 4 | A | B |
| 5 | A | B |
| 6 | A | A |
| 7 | A | A |
| 8 | A | A |
| 9 | A | A |
| 10 | A | A |
| 11 | A | A |
| 12 | B | A |
| 13 | B | A |
| 14 | C | A |
| 15 | C | A |
| 16 | A | A |
| 17 | A | A |
| 18 | A | A |
| 19 | B | B |
| 20 | B | B |
| 21 | B | B |

As shown in the above Table 4, the ink samples of No. 3 to No. 13 and No. 16 to No. 21 are all evaluated as acceptable for the performance of suppressing deformation and print quality. In these samples, water, propylene glycol, and isoprene glycol are contained in predetermined amounts, respectively. In particular, the ink samples of No. 6 to No. 11 and No. 16 to No. 18 are evaluated as A for both performance of suppressing deformation and print quality, and therefore have particularly excellent properties. It was confirmed that in these samples, the content of water in the ink is from 30 to 40% by mass of the total amount of the ink, which is an optimal water content.

It is shown that when the water content is less than 10% by mass, the image density is lowered and desired print quality is not obtained from the results of No. 1 and No. 2 Inks. Since the viscosity of No. 1 and No. 2 Inks is high, it is necessary to raise the temperature for favorably ejecting the ink from the inkjet head. In this manner, the condition for favorably ejecting No. 1 and No. 2 Inks from the inkjet head is narrow. On the other hand, No. 14 and No. 15 Inks in which the water content exceeds 50% by mass cannot suppress deformation of paper.

No. 6 to No. 11 Inks in which the content of the glycol mixture is from 54 to 64% by mass of the total amount of the ink are evaluated as A for both performance of suppressing deformation and print quality. It is shown that also in the case of containing a betaine compound, these properties are increased from the results of No. 16 to No. 18 Inks.

Further, No. 6 to No. 11 and No. 16 to No. 18 Inks showed excellent performance of suppressing deformation even for various types of plain paper other than Toshiba Copy Paper. In general, the deformation of paper depends on paper types. When the performance of suppressing deformation is examined as described above using paper which is liable to deform, the evaluated rate may be downgraded by one in some cases. Even in the case of using paper which is liable to deform, No. 6 to No. 11 and No. 16 to No. 18 Inks were evaluated as nearly A for the performance of suppressing deformation of paper. It was confirmed that these ink samples exhibit particularly excellent performance of suppressing deformation of paper.

The aqueous inkjet ink according to this embodiment can form a high quality image on a paper medium without deforming the paper medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An aqueous inkjet ink comprising:
water in an amount of from 15 to 50% by mass of a total amount of the ink;
a glycol mixture in an amount of from 34 to 80% by mass of the total amount of the ink, the glycol mixture comprising 40 to 70% by mass of propylene glycol, with a remainder being isoprene glycol; and
a pigment in an amount of from 2 to 20% by mass of the total amount of the ink.

2. The ink according to claim 1, wherein an amount of the water is from 30 to 40% by mass of the total amount of the ink.

3. The ink according to claim 1, wherein an amount of the glycol mixture is from 54 to 64% by mass of the total amount of the ink.

4. The ink according to claim 1, wherein the propylene glycol accounts for 50 to 70% by mass of the total amount of the glycol mixture.

5. The ink according to claim 1, wherein an amount of the pigment is from 3 to 6% by mass of the total amount of the ink.

6. The ink according to claim 1, further comprising a curling suppressing agent.

7. The ink according to claim 6, wherein the curling suppressing agent is selected from the group consisting of betaine, lauryl betaine, lauryl hydroxysulfobetaine, carboxybetaine, sulfobetaine, an aminocarboxylate, imidazolium betaine, lecithin, and an alkylamine oxide.

8. The ink according to claim 7, wherein an amount of the curling suppressing agent is from 5 to 15% by mass of the total amount of the ink.

9. The ink according to claim 6, wherein the curling suppressing agent is betaine.

10. The ink according to claim 9, wherein an amount of the betaine is from 10 to 15% by mass of the total amount of the ink.

11. The ink according to claim 1, further comprising a surfactant.

12. The ink according to claim 11, wherein an amount of the surfactant is from 0.5 to 2.0% by mass of the total amount of the ink.

13. The ink according to claim 1, wherein the pigment is a self-dispersion type pigment.

14. A method for inkjet printing comprising:
ejecting at least one type of ink composition from an inkjet head onto a paper medium to form an image, the ink composition being the inkjet ink according to claim 1.

15. The method according to claim 14, wherein the image is formed using one type of ink composition.

16. The method according to claim 14, wherein the image is formed using two or more types of ink compositions of different colors.
